(19) United States
(12) Patent Application Publication
(10) Pub. No.: US 2005/0098578 A1
(43) Pub. Date: May 12, 2005

(54) SYSTEM FOR DISPENSING REACTANT MIXTURES

(75) Inventor: Richard John Szymanski, Grosse Pointe Woods, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/604,462

(22) Filed: Jul. 23, 2003

Related U.S. Application Data
(60) Provisional application No. 60/410,756, filed on Sep. 13, 2002.

(51) Int. Cl. B67D 5/60

(52) U.S. Cl. 222/145.1

(57) ABSTRACT

A system for controlling dispensation of multiple component reactant mixtures. A mixing chamber is positioned adjacent to a part. A metering ram is actuated to pressurize at least two reactant components. The metering ram is stopped if a measured pressure value exceeds a predetermined pressure value. At least one flow meter measures a volume of a reactant component passing through the system.

### CROSS REFERENCE TO RELATED APPLICATIONS

This application claims the benefit of U.S. provisional application Ser. No. 60/410,756, filed Sep. 13, 2002.

### BACKGROUND OF INVENTION

1. Field of the Invention

The present invention relates to a system for controlling dispensation of multiple component reactant mixtures.

2. Background Art

Multiple component reactant mixtures are used to form polymeric compositions. Examples of polymers formed by reactant mixtures include epoxies, polyurethanes, and silicone compositions. For example, a silicone seal may be formed by combining a two-part reactant mixture including a catalyst component and a base component that may be mixed and injected to form the silicone seal in situ in an assembly.

Reactant mixtures are normally mixed in a mixing chamber of a gun injector that dispenses the mixture through a nozzle. The reactant components are provided under pressure to the mixing chamber via separate conduits. These separate conduits may include a flexible conduit portion. For example, the flexible conduit portion may be a hose. When a reactant component is provided under pressure into a flexible conduit portion, the flexible conduit portion may expand. As a result, the volume of a reactant component that is actually dispensed through the flexible conduit portion into the mixing chamber is not known. In addition, changes in temperature can affect the rate of expansion of the conduits, making it difficult to predict the volume of a reactant component that will be dispensed into the mixing chamber at any given time. Injecting an incorrect volume of a reactant component can result in an improper chemical reaction. For example, if an insufficient amount of the base component is provided, the chemical reaction may occur too fast. As a result, the reactant mixture may react and cure inside the nozzle before dispensing is complete, thereby necessitating replacement of the nozzle.

Before applicant's invention, there was a need for a system to control dispensation of reactant components and mixtures in order to dispense the desired amounts of the reactant components and the resultant reactant mixture. Problems associated with the prior art as noted above and other problems are addressed by applicant's invention as summarized below.

### SUMMARY OF INVENTION

According to the present invention, a reactant material dispensing system is provided in which at least two components are combined in a dispenser having a nozzle. The system includes a mixing chamber that receives two components under pressure from two separate sources. The two components are maintained separately before they are combined in the mixing chamber. A metering ram pressurizes the two components. A flow meter is provided to measure the volume of each component that passes through the system. Conduits are provided to fluidly connect the metering ram, flow meter, and mixing chamber.

Other aspects of the invention as it relates to the reactant material dispensing system are that the two components may be a catalyst and a base that are used to form a seal, in situ, in an article of manufacture. The mixing chamber may be connected to a robot arm that positions the mixing chamber and the nozzle adjacent to a part.

According to other aspects of the invention, a catalyst supply and a base supply may be connected in fluid flow communication to the metering ram. The metering ram pressurizes the reactant components. Alternately, individual metering rams may be used to pressurize each reactant component. Pressure may be monitored using a pressure sensor. The pressure sensor may be located between the metering ram and the mixing chamber. Shutoff valves may be located in a catalyst supply conduit that connects the catalyst supply to the metering ram, or in a base supply conduit that connects the base supply to the metering ram. Alternatively, shutoff valves may be provided in both the catalyst supply conduit and the base supply conduit.

According to another aspect of the invention, a catalyst conduit and a base conduit may be provided to connect the metering ram to the mixing head. A flow meter may be located in the catalyst conduit, in the base conduit, or in both the catalyst conduit and the base conduit. A catalyst gun valve may be located in the catalyst conduit. A base gun valve may be located in the base conduit.

### BRIEF DESCRIPTION OF DRAWINGS

FIG. 1 is a top plan view of a robot station for injecting a reactant mixture into a part on a conveyor.

FIG. 2 is a schematic front elevation view of a reactant mixture injection system.

FIG. 3 is a flowchart illustrating the method of controlling the reactant mixture injection system.

### DETAILED DESCRIPTION

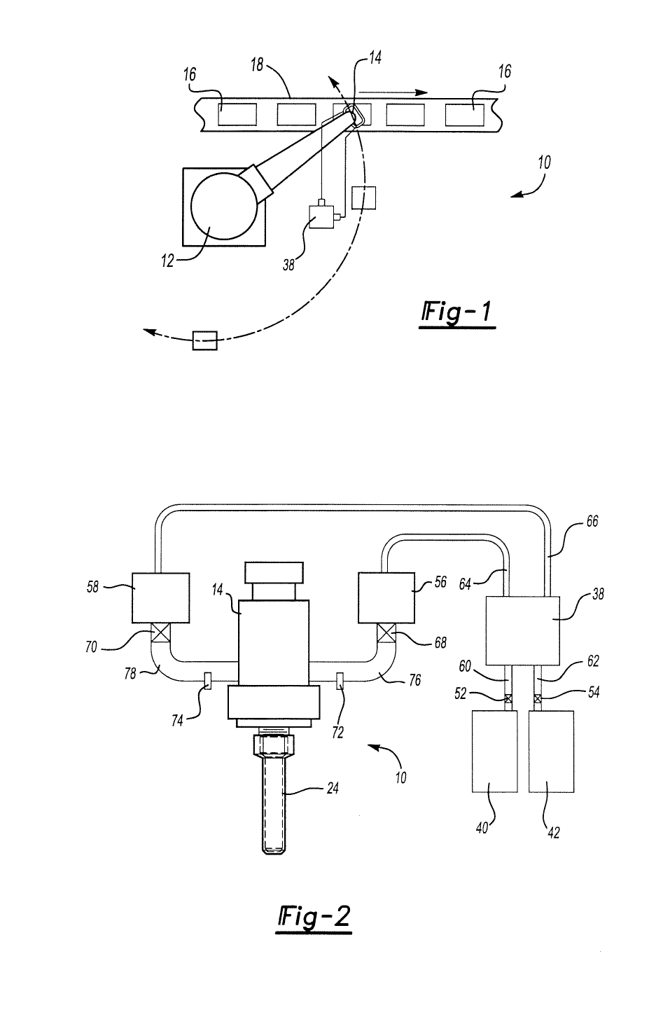

Referring now to FIG. 1, a multi-reactant injection system 10 is illustrated that may be used to inject a silicone sealant mixture on a production line. The system 10 uses a robot 12 to which a mixing chamber 14 is attached. A multiple component reactant mixture is injected through the mixing chamber 14 into a part 16 as it is moved by a conveyor 18.

Referring now to FIG. 2, the multi-reactant injection system 10 is shown in greater detail. A catalyst supply 40 provides a catalyst to a metering ram 38 through a catalyst supply conduit 60. A catalyst shutoff valve 52 may be located in the catalyst supply conduit 60 between the catalyst supply 40 and the metering ram 38. The catalyst shutoff valve 52 can be used to control the flow of catalyst to the metering ram 38 and to prevent catalyst from flowing back into the catalyst supply 40. Similarly, a base supply 42 provides a base to the metering ram 38 through a base supply conduit 62. A base shutoff valve 54 may be located in the base supply conduit 62 between the base supply 42 and the metering ram 38. The base shutoff valve 54 can be used to control the flow of the base to the metering ram 38 and to prevent the base from flowing back into the base supply 42.

The metering ram 38 injects the catalyst under pressure into a catalyst conduit 64 and injects the base under pressure into a base conduit 66. Optionally, individual metering rams could be used to pressurize the reactant components. For example, a first metering ram could be used to pressurize the base and a second metering ram could be used to pressurize the catalyst. The catalyst conduit 64 and the base conduit 66 can be made of a flexible material, such as rubber. Optionally, a portion of the catalyst conduit 64 or the base conduit 66 can be made of a flexible material while the remainder is made of a more rigid material such as steel or aluminum tubing.

The catalyst conduit 64 and the base conduit 66 fluidly connect the metering ram 38 to a catalyst flow meter 56 and a base flow meter 58, respectively. A typical flow meter contains sensors (not shown) that measure flow rate, density, temperature, and the volume of a reactant component that passes through the flow meter. Alternately, a single flow meter may be used in the multi-reactant injection system 10 to measure the volume of a reactant component.

The catalyst and the base are provided to the mixing chamber 14 by a catalyst junction conduit 76 and a base junction conduit 78. The catalyst junction conduit 76 connects the catalyst flow meter 56 to the mixing chamber 14. Similarly, the base junction conduit 78 connects the base flow meter 58 to the mixing chamber 14. The catalyst j unction conduit 76 may contain a catalyst gun valve 68 that controls the flow of the catalyst. Likewise, the base junction conduit 78 may contain a base gun valve 70 that controls the flow of the base. The catalyst gun valve 68 and the base gun valve 70 can be placed in close proximity to the mixing chamber 14 to reduce the possibility of reactant mixture entering the catalyst junction conduit 76 and the base junction conduit 78, respectively.

A catalyst pressure sensor 72 and a base pressure sensor 74 can be used to detect pressure in the multi-reactant injection system 10. The catalyst pressure sensor 72 can be located between the mixing chamber 14 and the metering ram 38. For example, the catalyst pressure sensor 72 could be located in the catalyst junction conduit 76, the catalyst gun valve 68, or the catalyst conduit 64. Likewise, the base pressure sensor 74 can be located between the metering chamber 14 and the metering ram 38 in locations such as the base junction conduit 78, the base gun valve 70, or the base conduit 66. Alternately, a single catalyst pressure sensor 72 or a single base pressure sensor 74 may be used to monitor pressure.

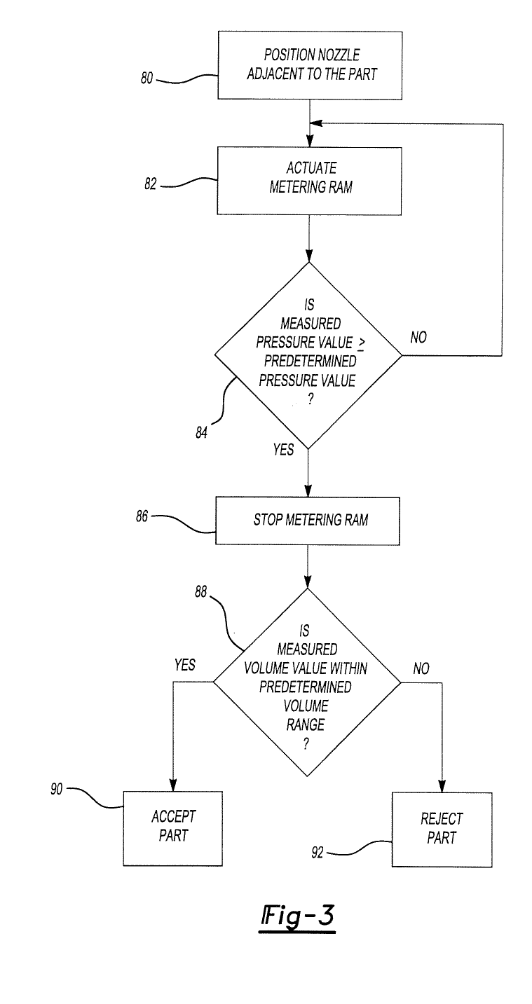

One embodiment of the process of the present invention is described with reference to FIG. 3. The process begins in the first step 80 with a robot 12 positioning the mixing chamber 14 and the nozzle 24 adjacent to the part 16. The catalyst shutoff valve 52, the base shutoff valve 54, the catalyst gun valve 68, and the base gun valve 70 are opened. Alternately, the catalyst shutoff valve 52, the base shutoff valve 54, the catalyst gun valve 68 and the base gun valve 70 can be opened before or at the same time the robot 12 positions the mixing chamber 14 and the nozzle 24 adjacent to the part 16.

Next, at 82, the metering ram 38 is actuated to pressurize the multi-reactant injection system 10 and dispense the reactant mixture through the mixing chamber 14 and the nozzle 24 and into the part 16. Alternately, the catalyst shutoff valve 52 and the base shutoff valve 54 can be closed before the metering ram is advanced to prevent the reactant components from being pushed back into the catalyst supply 40 and the base supply 42.

At 84, a measured pressure value is compared to a predetermined pressure value. If the measured pressure value is less than the predetermined pressure value, the actuation of the metering ram 38 continues as depicted by the loop returning to 82. The measured pressure value is provided by the catalyst pressure sensor 72 or the base pressure sensor 74. Alternately, the measured pressure value can be provided by both the catalyst pressure sensor 72 and the base pressure sensor 74.

At 86, if the measured pressure value is greater than or equal to the predetermined pressure value, the metering ram 38 is stopped. In another embodiment the catalyst gun valve 68 and the base gun valve 70 may be closed before stopping the metering ram 38. In yet another embodiment, the catalyst shutoff valve 52 and the base shutoff valve 54 may be closed before stopping the metering ram 38. In still another embodiment the catalyst shutoff valve 52, the base shutoff valve 54, the catalyst gun valve 68, and the base gun valve 70 can be closed before stopping the metering ram 38.

In the next step, at 88, a measured volume value is compared to a predetermined volume range. The measured volume value is the volume of a reactant component that passes through a flow meter. The measured pressure value is provided by a catalyst flow meter 56 or a base flow meter 58. If the measured volume value is within the predetermined volume range the part is accepted as shown at 90. If the measured volume value is outside the predetermined volume range, then the part is rejected as shown at 92. In another embodiment, the measured volume value is provided by both the catalyst flow meter 56 and the base flow meter 58.

While the best mode for carrying out the invention has been described in detail, those familiar with the art to which this invention relates will recognize various alternative designs and embodiments for practicing the invention as defined by the following claims.

1. A reactant material dispensing system wherein at least two components are combined comprising:
a metering system that pressurizes the at least two components;
a flow meter that measures a volume of a component passing within;
a conduit fluidly connected between the metering ram and the flow meter;
a mixing chamber that receives the at least two components under pressure;
a nozzle through which a mixture of the at least two components flows.

2. The dispensing system of claim 1 wherein the two components are a catalyst and a base used to form a seal in an article of manufacture.

3. The dispensing system of claim 1 wherein the metering system further comprises a first metering ram that pressurizes the catalyst and a second metering ram that pressurizes the base.

4. The dispensing system of claim 1 wherein a shutoff valve is located between a supply and the metering ram.

5. The dispensing system of claim 1 wherein a first shutoff valve is located between a catalyst supply and the metering ram and a second shutoff valve is located between a base supply and the metering ram.

6. The dispensing system of claim 1 wherein the mixing chamber is connected to a movable robot arm.

7. The dispensing system of claim 1 wherein a first flow meter is located between a first conduit and the mixing chamber and a second flow meter is located between a second conduit and the mixing chamber.

8. The dispensing system of claim 1 wherein a gun valve is located between the flow meter and the mixing chamber.

9. The dispensing system of claim 1 wherein a first gun valve is located between the first flow meter and the mixing chamber and a second gun valve is located between the second flow meter and the mixing chamber.

10. The dispensing system of claim 1 wherein a pressure sensor is located between the metering system and the nozzle.

11. The dispensing system of claim 1 wherein a first pressure transducer is located between the first flow meter and the nozzle and a second pressure transducer is located between the second flow meter and the nozzle.
